(19) United States
(12) Patent Application Publication
(10) Pub. No.: US 2003/0002458 A1
(43) Pub. Date: Jan. 2, 2003

(54) System and method for providing a communication system configurable for increased capacity

(76) Inventor: Henrik F. Bernheim, Bellevue, WA (US)

Correspondence Address: Duane Morris LLP, 1667 K Street, NW, Suite 700, Washington, DC, 20006, US

(21) Appl. No.: 09/893,431

(22) Filed: Jun. 29, 2001

(51) Int. Cl. H04Q 11/00; H04L 12/56

(52) U.S. Cl. 370/330; 370/408

(57) ABSTRACT

A communication system is adapted to accommodate changes in bandwidth demand through the use of modular components. According to a preferred embodiment a plurality of communication interface modules, such as radio modules, are coupled to a communication signal processor, such as a multi-port modem, in order to serve an initial bandwidth demand. Thereafter, additional communication signal processors may be added, being coupled to one or more of the communication interface modules decoupled from the initially deployed communication signal processor, to serve an increased bandwidth demand. Preferably, an expansion chassis architecture is used to accommodate a number of communication signal processors at least equivalent to the number of communication information interfaces of the plurality. In preferred embodiments, the communication interface modules operate upon different channels, such as radio frequency channels, although coupling to the communication signal processor upon a same channel, such as a common intermediate frequency channel.

### RELATED APPLICATIONS

The present application is related to and is being concurrently filed with commonly assigned United States patent applications entitled “FREQUENCY REUSE FOR POINT TO MULTIPOINT APPLICATIONS”and “SYSTEM AND METHOD FOR PROVIDING REDUNDANCY IN A SECTORED WIRELESS COMMUNICATION SYSTEM”, the disclosures of which are hereby incorporated herein by reference. The present application is also related to copending and commonly assigned U.S. Pat. No. 6,016,313 entitled “SYSTEM AND METHOD FOR BROADBAND MILLIMETER WAVE DATA COMMUNICATION”, issued Jan. 18, 2000 and copending and commonly assigned U.S. patent applications Ser. No. 09/434,832, entitled “SYSTEM AND METHOD FOR BROADBAND MILLIMETER WAVE DATA COMMUNICATION,” filed Nov. 5, 1999, and Ser. No. 09/327,787, entitled “MULTI-LEVEL INFORMATION MAPPING SYSTEM AND METHOD,” filed Jun. 7, 1999, the disclosures of which are hereby incorporated herein by reference.

### TECHNICAL FIELD

The present invention relates generally to wireless communication system and, more specifically, to the ability to build out communication infrastructure as demand for capacity increases.

### BACKGROUND

In the past, information communication between processor-based systems, such as local area networks (LAN) and other general purpose computers, separated by significant physical distances has been an obstacle to integration of such systems. The choices available to bridge the physical gap between such systems have not only been limited, but have required undesirable tradeoffs in cost, performance, and reliability.

One group of historically available communication choices includes such solutions as the utilization of a standard public switch telephone network (PSTN) or multiplexing signals over an existing physical link to bridge the gap and provide information communication between the systems. Although such solutions are typically inexpensive to implement, the include numerous undesirable traits. Specifically, since these existing links are typically not designed for high speed data communication, they lack the bandwidth through which to communicate large amounts of data rapidly. As in-building LAN speeds increase to 100 Mbps, the local PSTN voice grade circuits even more markedly represent a choke point for broadband metropolitan area access and therefore are becoming a less and less desirable alternative. Furthermore, such connections lack the fault tolerance or reliability found in systems designed for reliable transmission of important processor-based system information.

Another historically available group of communication choices is found at the opposite end of the price spectrum than those mentioned above. This group includes such solutions as the utilization of a fiber optic ring or point-to-point microwave communication. These solutions are typically cost prohibitive for all but the larger users. The point-to-point systems require a dedicated system at each end of the communication link which lacks the ability to spread the cost of such systems over a plurality of users. Even if these systems were modifiable to be point-to-multipoint, to realize the economy of multiple system use of some system elements, the present point-to-point microwave systems would not provide broadband data services but rather traditional bearer services such as TI and DS3. Furthermore these systems typically provide a proprietary interface and therefore do not lend themselves to simple interfacing with a variety of general purpose processor-based systems.

Although a fiber optic ring provides economy if utilized by a plurality of systems, it must be physically coupled to such systems. As the cost of purchasing, placing, and maintaining such a ring is great, even the economy of multi-system utilization generally does not overcome the prohibitive cost of implementation.

Accordingly, point-to-multipoint systems such as shown and described in above referenced U.S. Pat. No. 6,016,313, entitled “System and Method for Broadband Millimeter Wave Data Communication,” have been developed to provide broadband communication infrastructure in an efficient and economical alternative. For example, a preferred embodiment point-to-multipoint system described in the U.S. Pat. No. 6,016,313 provides for a network of point to multipoint hubs to establish cellular type coverage of a metropolitan area. Such systems are generally more economical to deploy than systems such as fiber optic networks, due to their use of wireless links avoiding the cost of laying fiber to all nodes on the network, and point-to-point microwave, due to the sharing of resources among several or many users. However, the cost of equipment, deployment, and maintenance is still appreciable in such systems.

The cost to initially deploy a communication system may be reduced by optimizing the equipment actually deployed to the actual subscribed capacity or the near term expected demand for capacity. A particular metropolitan area, although including many businesses and other entities having a need for broadband communication within a several mile radius of its center, may initially have a small subset of entities actually ready for utilization of such services.

For example, a portion of the business entities may initially forego the use of needed broadband communication because of such reasons as corresponding entities have not yet adopted the technology. Additionally, some portion of the entities having a need for broadband communication may have already adopted an earlier generation of broadband communication or quasi broadband solution, thus having expended a large some of resources and capital, and therefore not yet be willing to adopt a recently introduced superior and/or less expensive solution. However, some subset of the entities having a need for broadband communication, possibly scattered throughout the metropolitan area, may have an immediate or near term desire and willingness to adopt the technology. In the somewhat longer term, more such entities may develop the desire and willingness to adopt the technology, such as due to others successfully adopting the technology, having fully realized the capital expense of a previously adopted system, or due to new entities arriving in the metropolitan area.

Where communication system infrastructure is optimized for the immediate or near term demand, a system may be deployed which economically and efficiently serves the demands of subscribers. Specifically, the actual equipment deployed may be substantially limited to only that which is currently or in the near term subscribed, thereby avoiding the expense of equipment which may remain unused or under utilized for some time to come. Moreover, deploying only that equipment which is currently necessary reduces maintenance and operating costs as there is a reduced set of equipment requiring service, repair, and other continuing operating costs.

However, deployment of a system optimized for current or near term demand may at some time in the future, or even very quickly, provide less than optimal service as demand increases. A need therefore exists in the art for a system and method of providing desired communications optimized for an initial demand which is later configurable to serve increased demand. Preferably, such systems and methods are adapted to provide broadband communication services. A further need exists in the art for such systems and methods to provide cost effective bridging of large physical distances between processor-based systems.

These and other objects, features and technical advantages are achieved by a system and method which allows the provision of added communication capacity through addition of components to previously deployed and suitably adapted communication equipment. Accordingly, communication infrastructure is provided to serve an initial level of capacity, such as that currently demanded or subscribed within a predefined service area. Preferably the communication infrastructure utilized according to the present invention is modular or includes modular components in order to facilitate supplemental equipment deployment in order to accommodate subsequent changes in demand and/or subscription. Various embodiments of the present invention may be deployed which accommodate subsequent increases in demand, decreases in demand, and both increases and decreases in demand.

According to a preferred embodiment of the present invention, a communication hub is provided having a communication signal processor, providing an associated finite level of communication bandwidth, coupled to a plurality of communication link interfaces providing communication links with an initial set of subscriber communication units. However, as communication demands change over time, such as increase due to an increased number of subscriber communication units, additional communication signal processors, providing associated finite levels of communication bandwidth, are added to the communication hub to thereby provide increased capacity. Preferably, one or more of the communication link interfaces are decoupled from the initial communication signal processor in favor of coupling to the added communication signal processors to thereby distribute the available capacity throughout the communication links.

For example, in a situation where only one of the communication links experiences a significant increase in demand, the associated communication link interface may be decoupled from the initial communication signal processor and coupled to a newly added communication signal processor to thereby provide increased capacity to the one link experiencing a significant increase in demand as well as to provide the then freed capacity of the initial communication signal processor to one or more of the other communication links. In another example, in a situation where the communication links each experience a similar increase in demand, the communication link interfaces may be approximately evenly divided among a initial communication signal processor and newly added communication signal process or to thereby provide a similar increase in available capacity to the links.

According to a most preferred embodiment of the present invention, wherein wireless communication links are utilized, the above described communication signal processor is a modem. Also according to a most preferred embodiment, the communication link interfaces are radio modules, each preferably adapted to provide directional radio communication. For example, a plurality of radio modules may be deployed, such as up a hub mast, to provide substantially sectored communications, i.e., radios oriented to provide communications within sections of a service area, with a multi-port modem disposed in a radio shack associated therewith and coupled to each of the radio modules.

According to a preferred embodiment of the present invention, the addition of capacity to the system is greatly simplified by allowing system alterations to be made from an easily accessed, and preferably single, location. For example, when a particular communications hub of a most preferred embodiment requires additional capacity, a service technician may be dispatched with one or more additional multi-port modems to the hub's radio shack to decouple one or more radio modules from the existing one or more modem, install one or more new modem, and couple one or more of the radio modules to new modems. In such an embodiment, the service technician is enabled to add the desired capacity without any changes to the systems deployed up-mast.

Preferred embodiments of the present invention allow for the addition of communication capacity not only through added communication signal processors, but also through the addition of communication link interfaces. Accordingly, in a preferred embodiment radio modules may be added to provide additional capacity. For example, in a most preferred embodiment wherein radio modules are utilized to provide sectorized coverage of a service area, increased capacity may be accommodated through the addition of radio modules to further sectorize the service area and, thereby, divide demand experienced in a particular area among available ones of the modems. Additionally or alternatively, increased capacity may be accommodated through the addition of radio modules to provide overlapping coverage of a sector or sectors and, thereby, divide demand experienced therein among available ones of the modems.

The foregoing has outlined rather broadly the features and technical advantages of the present invention in order that the detailed description of the invention that follows may be better understood. Additional features and advantages of the invention will be described hereinafter which foam the subject of the claims of the invention. It should be appreciated by those skilled in the art that the conception and specific embodiment disclosed may be readily utilized as a basis for modifying or designing .other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1A shows a block diagram of a preferred embodiment communication hub of the present invention having an initial deployment configuration;

FIG. 1B shows a schematic diagram of a preferred embodiment multi-port modem of the present invention;

FIG. 2 shows a sectored service area served by the communication hub of FIG. 1 A at an initial deployment;

FIG. 3 shows a communication frame such as may be utilized by the communication hub of FIG. 1A;

FIG. 4 shows the sectored service area of FIG. 2 at a subsequent time;

FIG. 5 shows a block diagram of the communication hub of FIG. 1A having a subsequent configuration;

FIG. 6 shows a communication frame such as may be utilized in conjunction with the communication frame of FIG. 3 by the communication hub of FIG. 5;

FIG. 7 shows a preferred embodiment expansion bus structure useful in providing a communication hub according to the present invention;

FIGS. 8 and 9 show the expansion bus structure of FIG. 7 having alternative configurations; and

FIG. 10 shows the expansion bus structure of FIG. 7 having an optional secondary expansion bus structure associated therewith.

### DETAILED DESCRIPTION

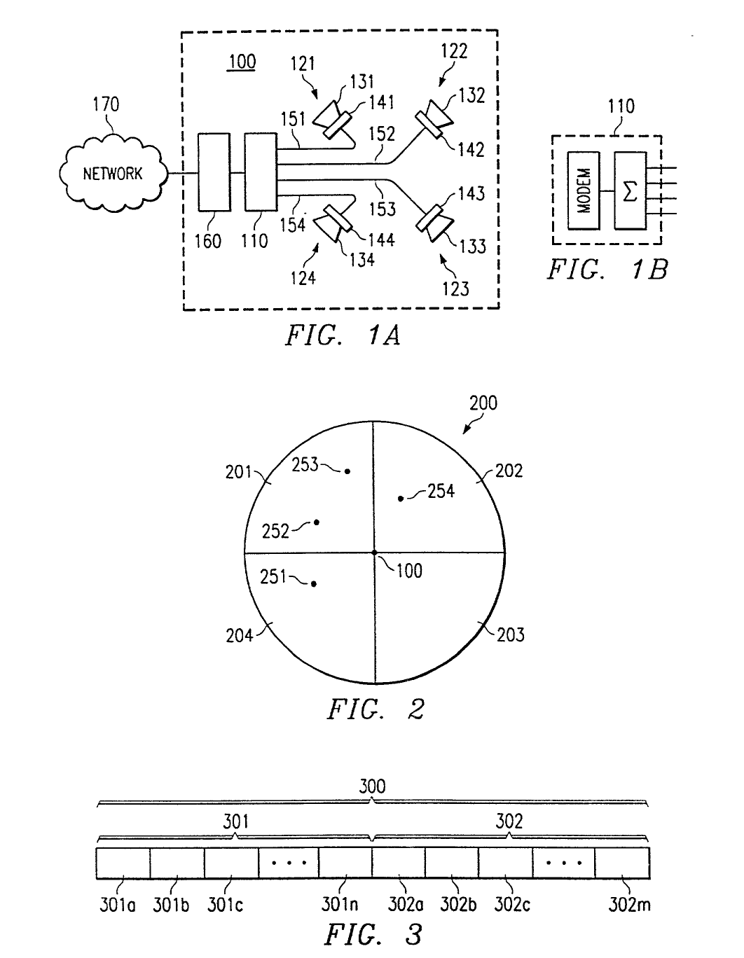

FIG. 1A shows communication hub 100 adapted according to a preferred embodiment of the present invention. Specifically, the illustrated embodiment of hub 100 includes a communication signal processor, shown as multi-port modem 110, coupled to a plurality of communication interface modules, shown as radio modules 121-124, via signal paths 151-154. As shown in FIG. 1A, a communication signal processor of the hub may be coupled to additional communications apparatus, such as a network interface, data router, and/or the like, shown in the preferred embodiment as switch 160, which may include controller logic, such as a processor (CPL)), memory (RAM), and instruction set suitable for intelligently controlling communications between communication hub 100, nodes 251-254, and/or network 170. Likewise, the hub may be provided external communications, such as to network service providers, communications carriers, subscriber units, additional communication hubs, and/or the like, shown in the preferred embodiment as network 170. Network 170 may be any form of communication network, such as a public switched telephone network (PSTN), a loci area network (LAN), a wide area network (WAN), the Internet, a cable communication system, a cellular network, a fiber optic network such as SONET or SDH, and/or the like.

Multi-port modem 110 may be provided in a number of configurations. For example, switching circuitry to provide selectable and/or controlled coupling of a signal between multi-port modem 110 and radio modules 121-124 may be utilized. However, a preferred embodiment of the present invention utilizes signal splitter/combiner techniques, such as schematically illustrated in FIG. 1B, to couple a signal between multi-port modem 110 and radio modules 121-124.

Preferably the communication interface modules utilized according to the present invention are adapted to provide a plurality of diverse communication links and, thereby, provide communication services to various individual subscribers. For example, a preferred embodiment shown in FIG. 2 defines service area 200 wherein radio module 121-124 provide communications within sectors 201-204 respectively. Accordingly, antennas 131-134 of radio modules 121-124 are preferably directional antennas having a predetermined beamwidth, such as 90° in the illustrated embodiment. By properly orienting each of radio modules 121-124, service area 200 may be defined as a 360° area around communication hub 100.

Accordingly, various subscriber units, shown in FIG. 2 as remote nodes 251-254, disposed with service area 200 may be provided communication links through communication interface modules 121-124 and communication signal processor 110, such as to network 170 and/or systems coupled thereto. Nodes utilized according to the present invention may include an antenna coupled to a modem, such as through a front-end module converting between RF and IF frequencies, itself coupled to a customer premise equipment interface. However, it shall be understood that any number of component configurations are acceptable for use at nodes 251-254.

It should be appreciated that communication hub 100 may be part of a larger communication network. For example, a plurality of communication hubs, possibly in communication through backbone links such as may be provided by network 170 and/or through the use of airlinks between the hubs, may be disposed throughout a metropolitan area to provide communication services. A cellular coverage pattern might be implemented such that a plurality of service areas substantially blanket a larger area, such as is shown and described in above referenced U.S. Pat. No. 6,016,313.

According to the present invention, communication hub 100 is initially configured to service a first communication capacity. For example, nodes 251-254 may initially be identified for providing broadband communication services, such as by guaranteeing a particular quality of service and/or a predefined amount of available bandwidth, to ones of these nodes. Accordingly, the components of communication hub 100 may be substantially optimized to provide the desired communications. For example, modem 110 may be selected to provide the aggregate subscribed bandwidth, preferably including some excess capacity to accommodate near term increases in demand. Likewise, a number and/or configuration of radio modules 121-124 are selected to provide adequate coverage of the nodes. Specifically the sector sizes may be selected to provide substantially equally distributed coverage of the service area and/or of the nodes to be served. Additionally or alternatively, the number of sectors may be selected to provide a relatively small number of sectors, although being sufficient in number to provide benefits associated with sectorization. Accordingly, the preferred embodiment initial communication hub configuration illustrated in FIG. 1A includes a single multi-port modem coupled to four radio modules to provide an initial configuration suitable for communications with nodes 251-254 using a relatively small number of communications components.

It should be appreciated that the configuration illustrated herein is merely exemplary and is not a limitation of the present invention. For example, more or less communication interface modules may be utilized by a communication hub of the present invention. Likewise, there is no limitation to the use of a particular antenna beamwidth and/or their orientation to provide either substantially non-overlapping coverage or composite 360° coverage.

However, preferred embodiments of the present invention initially provide communication coverage throughout the entire area to be serviced, even when demand does not currently exist in particular portions thereof, to thereby facilitate servicing future demand. Such embodiments are preferred as it is often desirable to reduce or eliminate the requirement that a service technician ascend a communication mast after deployment, such as to install communication interface modules. By initially deploying communication interface modules sufficient in number and/or orientation to allow communications throughout the entire area to be serviced, increases in demands for capacity associated with the addition of nodes in areas in which nodes previously did not exist may be addressed according to the present invention without requiring any up-mast alterations.

Of course, it should be appreciated that preferred embodiments of the present invention utilize modular communication interface components and, therefore, may be further optimized initially to omit communication interface modules not currently required. For example, radio module 123 associated with sector 203, having no nodes initially disposed therein, may be omitted from the initial configuration communication hub 100, such as where there is easy access to the deployed radio modules and/or where it is not desired to accommodate addition of capacity from centralized location.

The service area sectors of a preferred embodiment of the present invention utilize different communication channels or channel sets, such as different time division channels (TDMA), code division channels (CDMA), and/or frequency division channels (FDMA). Additionally or alternatively, other techniques for providing signal orthogonality may be relied upon in isolating signals of different sectors according to the present invention. For example, orthogonal polarization between sectors may be utilized. Similarly, where there is sufficient isolation provided by the communication interfaces, diversity techniques, such as spatial and/or angular, i.e., different antenna “views,” may be utilized to isolate the sector signals according to the present invention. The provision of substantially isolated signals within the sectors of the preferred embodiment is preferred in order to facilitate increased capacity by allowing contemporaneous communications to be conducted in the sectors with minimized interference there between.

In a preferred embodiment, frequency division multiple access (FDMA) techniques are utilized across sectors of the communication hub, Using unique frequency division channels or channel sets among the sectors of a service area facilitates increased capacity by allowing simultaneous communication between nodes disposed in various ones of the sectors and the communication hub, while avoiding interference. Accordingly, in a preferred embodiment of the present invention one or more of sectors 201-204 utilize channels or channel sets of frequencies different than another one or more of the sectors. As will be better understood from the discussion that follows, the use of such different channels or channel sets among the sectors is present in preferred embodiments of the invention even in an initial configuration utilizing a single modem to serve each such sector.

A preferred embodiment of the present invention provides communication services to a plurality of subscribers using multiplexing techniques, such as the most preferred technique of time division multiple access (TDMA). Accordingly, a communication frame utilized according to the present invention, such as frame 300 of FIG. 3, may include a plurality of burst periods, such as burst periods 301a-301n and 302a-302m. Preferred embodiments of the present invention may also utilize time division duplexing (TDD), such as may be accomplished using forward link frame portion 301, having burst periods 301a-301n associated therewith, and reverse link frame portion 302, having burst periods 302a-302m associated therewith. It should be appreciated that the frame lengths, the burst period lengths, and/or the numbers of burst periods utilized according to the present invention may be selected to be any suitable value. Moreover, there is no limitation that the values be constant or symmetric. For example, the length of the forward link frame portion may be different than that of the reverse link frame portion, where asymmetric demand is present. Furthermore, the boundary between these frame portions maybe dynamically adjustable to provide dynamic asymmetric time division duplexing, as shown and described in above referenced U.S. Pat. No. 6,016,313.

In operation according to a preferred embodiment wherein TDMA signals are utilized to provide communication between a plurality of nodes and the communication hub and wherein frequency division channels are utilized among the sectors of the communication hub, communication hub 100 allocates burst periods of a TDMA frame among the nodes in communication therewith in order to provide desired bandwidth communications to each such node. However, as nodes 251-254 are disposed in various ones of sectors 201, 202, and 204, radio modules 121, 122, and 124 are in communication with the nodes of this preferred embodiments at different frequencies. Accordingly, the preferred embodiment modem 110, providing communication signal processing of the TDMA signal for each of these nodes, does so at a particular intermediate frequency (IF). To facilitate the use of this common IF at the radio modules of the different sectors, the preferred embodiment radio modules 121-124 include front end module 141-144 respectively. Front end modules 141-144 of a preferred embodiment are synthesized radio frequency (RF), such as microwave or millimeter wave, front-end modules accepting and transmitting radio frequency energy through antennas 131134 converted to/from the common IF for communication with modem 110.

For example, initial communication demand may be served by communication hub 100, such as under control of a controller of communication hub 100 or of a network of communication hubs (not shown), assigning one or more of forward link burst periods 301a-301n and/or reverse link burst periods 302a-302m to particular ones of nodes 251-254 demanding communication services. As a specific example where each of nodes 251-254 demand equal and symmetric bandwidth,. assuming frequency channels F1-F4 being assigned to sectors 201-204 respectively, burst periods 301a and 302a may carry information associated with node 251 on channel F4, burst periods 301b and 302b may carry information associated with node 252 on channel F1, burst periods 301c and 302c may carry information associated with node 253 on channel F1, and burst periods 301n and 302m may carry information associated with node 254 on channel F2.

Of course there is no requirement according to the present invention that the nodes be assigned a same number of burst periods as the other nodes and/or as a corresponding link direction. For example, where a node does not require bandwidth in a particular link direction, it may not have burst periods assigned, or a reduced number of burst periods assigned, in that link direction. Likewise, where one node requires a large amount of bandwidth and another node does not require a similar amount of bandwidth, a larger number and/or length of burst periods may be associated the node requiring the large amount of bandwidth.

As demand for communication services increase, communication hub 100 may be operated to serve some increased demand through allocation of the available resources without the need for configuration alteration. For example, if a node is added to the service area 200, assignment of burst periods may be adjusted to accommodate the added demand. However, at some point it is envisioned that an increase in demand will surpass communication hub 100's ability to adequately service the demand without configuration alteration according to the present invention.

Directing attention to FIG. 4, a situation where the number on nodes within service area 200 approximately doubles through bringing online nodes 451-453. Accordingly, it is expected that the associated communication bandwidth demand will also increase appreciably. Such a situation may present bandwidth demand at a level no longer adequately serviceable by the configuration of FIG. 1A having only a single modem 110. Accordingly, a second modem is preferably added to communication hub 100 to share in serving the demand according to the present invention.

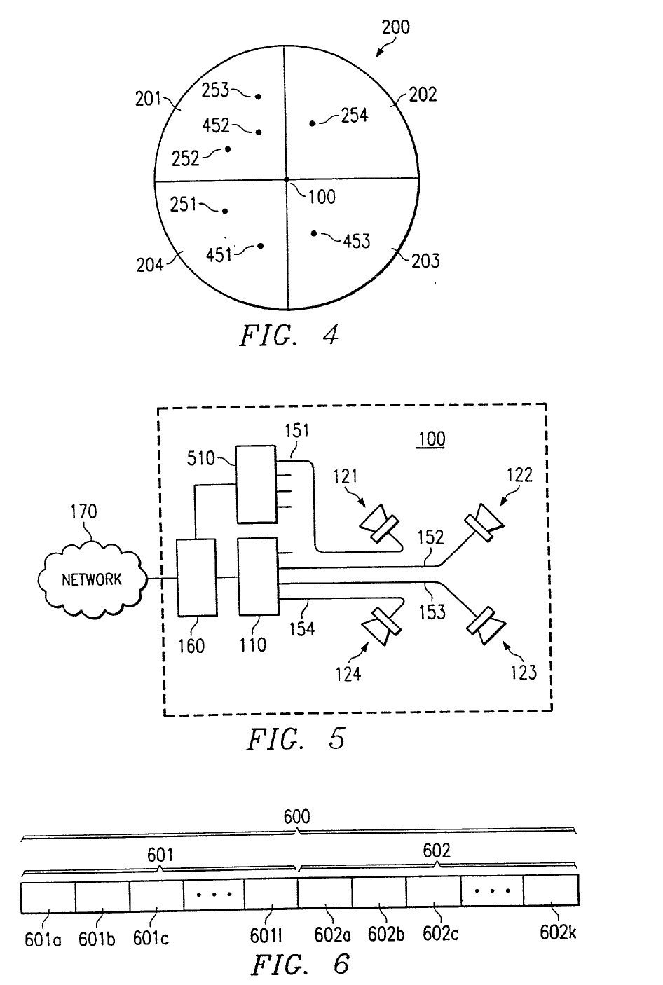

Referring now to FIG. 5, a preferred embodiment subsequent configuration of communication hub 100, configured to optimally serve increased demand, is shown. Specifically, a second multi-port modem 510 has been added to provide additional communication signal processing capacity. For example, modems 110 and 510 may provide signal processing at a same baud rate and, therefore, the configuration of FIG. 5 theoretically provide double the capacity as that of FIG. 1A. It should be appreciated that the double capacity increase of FIG. 5 is theoretical because, in a preferred embodiment, modems 110 and/or 510 provide information communication in varying information densities, such as through the use of phase shift keying (PSK) or quadrature amplitude modulation (QAM), which may allow higher capacity with respect to particular links and/or nodes.

It should be appreciated that a multi-port modem is not required in the configuration of FIG. S wherein modem 510 is coupled to a single radio module. Accordingly, rather than the preferred embodiment multi-port modem, a single port modem may be utilized, if desired. However, it is preferred that a multi-port modem be utilized in some embodiments of the present invention in order to facilitate configuration changes in response to future changes in bandwidth demand. As the most preferred embodiment multi-port modem utilizes relatively inexpensive signal splitting/combining techniques, it is envisioned that the use of such a multi-port modem where all such ports are not currently required will optimally provide for future flexibility. Of course, a single port, or other reduced number of ports, modem may be utilized according to the present invention, with future demand being accommodated through the addition of modem signal splitting/combining components, modem signal switching components, or even the exchange of the modem for one having a different number of ports.

As discussed above, the preferred embodiment of the present invention provides communication services to a plurality of subscribers using multiplexing techniques, such as the most preferred technique of time division multiple access (TDMA). Accordingly, a communication frame utilized with respect to modem 510 is shown as frame 600 of FIG. 6, including a plurality of burst periods, such as burst periods 601a-601l and 602a-602k. The preferred embodiment also utilizes time division duplexing (TDD) and, therefore, includes forward link frame portion 601, having burst periods 601a-601l associated therewith, and reverse link frame portion 602, having burst periods 602a-602k associated therewith. As with frame 300 discussed above with respect to modem 110, the burst period lengths, and/or the numbers of burst periods utilized according to the present invention may be selected to be an suitable value. Moreover, there is no limitation that the frames or burst periods coincide wit those of frame 300. For example, the length of the forward link frame portion of frame 600 may be different than that of the forward link frame portion of frame 300.

In reconfiguring communication hub 100 according to the preferred embodiment of the present invention, one or more of the communication interface modules initially deployed are preferably decoupled from the initially deployed communication signal processor in favor of connection to the newly installed communication signal processor. For example, in the preferred embodiment of FIG. 5 radio module 121 is decoupled from multi-port modem 110 and coupled to multi-port modem 510. Selection of a radio module or modules to couple to a newly added modem may be made based on a number of criteria, including a sector or sectors experiencing demand most closely matching the capacity of a particular modem, sectors serving nodes with a common quality of service, splitting sectors to distribute particular communication attributes between the modems, such as distributing demand or bursty behavior among the modems, and/or the like. In the embodiment illustrated in FIG. 5, radio module 121 and radio modules 122-124 are selected for providing to modems of equal capacity in order to substantially evenly distribute communication bandwidth among the two modems. Specifically, in the simplified example of FIG. 5, it is assumed that each of nodes 251-254 and 451-453 are operable at a same data rate and similar bandwidth requirements. Accordingly, coupling radio module 121 to modem 510 and radio modules 202-204 to modem 110 substantially evenly divides service of nodes 252, 253, and 452 (modem S 10) and nodes 251, 254, 451, and 453 (modem 110) among the modems.

It should be appreciated from FIGS. 4 and 5 that providing expanded capacity to the initial configuration of FIG. 1A may be accomplished according to the present invention without a service technician having to ascend a mast upon which radio modules 121-124 are preferably disposed. Instead, a service technician may enter a radio shack or other service closet associated with communication hub 100, install additional modem equipment, such as a modem card, and affect a switch of coupling one or more radio units to the new modem. Because the preferred embodiment initial configuration included radio module 123, serving sector 203, even though no service was initially demanded, added bandwidth demand originating in this sector is easily served (and quite possibly could be served without any service technician intervention what-so-ever as discussed above).

Of course, the initial configuration may be further optimized to the initially existing demand by not providing, then unneeded, radio module 123. Because of the preferred embodiment modularity of the system components, radio module 123 maybe deployed only when communication service is required in sector 203. However, experience has revealed that most service providers prefer a solution which optimizes the amount of configuration alternation which may be performed without requiring up-mast modifications. Given the expected cost of a radio module, it is believed the incremental cost of inclusion of the initially unused radio module provides such an optimized configuration.

The use of a common IF for each radio module of the initial deployment facilitates the easy interchange of radio module to modem connections described herein. Of course, rather than using a common IF among the radio modules, alternative embodiments of the present invention may match radio module IFs to particular ports of the multi-port modems, thereby facilitating interchange of radio modules and modem connections, but only between particular ports of the multi-port modems. Such an alternative embodiment would likely decrease flexibility in selecting radio module distribution among the available modems, but may be desirable in order to accommodate particular radio frequencies at the radio modules or for other reasons.

It should also be appreciated from FIGS. 4 and 5 that, because the preferred embodiment initial configuration includes signal orthogonality between the sectors of service area 200, which in the most preferred embodiment shown includes the use of frequency division channels, signals carrying the increased capacity associated with newly added modem 510 may be provided substantially simultaneously with and independent of signals carrying the capacity associated with original modem 110. For example, in operation according to a preferred embodiment wherein TDMA signals are utilized to provide communication between a plurality of nodes and the communication hub, communication hub 100 allocates burst periods of TDMA frames among the nodes in communication therewith in order to provide desired bandwidth communications to each such node. Specifically, communication demand may be served by communication hub 100, such as under control of a controller of communication hub 100 or of a network of communication hubs (not shown), assigning one or more of forward link burst periods 301a-301n and/or reverse link burst periods 302a-302m (modem 110) to particular ones of nodes 251, 254, 451, and 453 demanding communication services and one or more of forward link burst periods 601a-601l and/or reverse link burst periods 602a-602k (modem 510) to particular ones of nodes 252, 253, and 452. As a specific example where each of nodes 251-254 and 451-453 demand equal and symmetric bandwidth, assuming frequency channels F1-F4 being assigned to sectors 201-204 respectively, burst periods 301a and 302a may carry information associated with node 251 on channel F4, burst periods 301b and 302b may carry information associated with node 451 on channel F4, burst periods 301c and 302c may carry information associated with node 254 on channel F2, and burst periods 301n and 302m may carry information associated with node 453 on channel F3. Independently, burst periods 601a and 602a may carry information associated with node 252 on Channel F1, burst periods 601b and 602b may carry information associated with node 253 on channel F1, and burst periods 601c and 602c may carry information associated with node 452 on channel F1.

In order to better aid configuration changes at the communication hub, preferred embodiments of the present invention utilize components adapted to easily accept added components and/or allow removal of components. For example, a preferred embodiment of the present invention utilizes an easily configurable radio module mounting structure, such as shown and described in copending and commonly assigned U.S. patent application Ser. No. 09/267,492, filed Mar. 12, 1999 and entitled “Antenna Frame Structure Mounting and Alignment.”

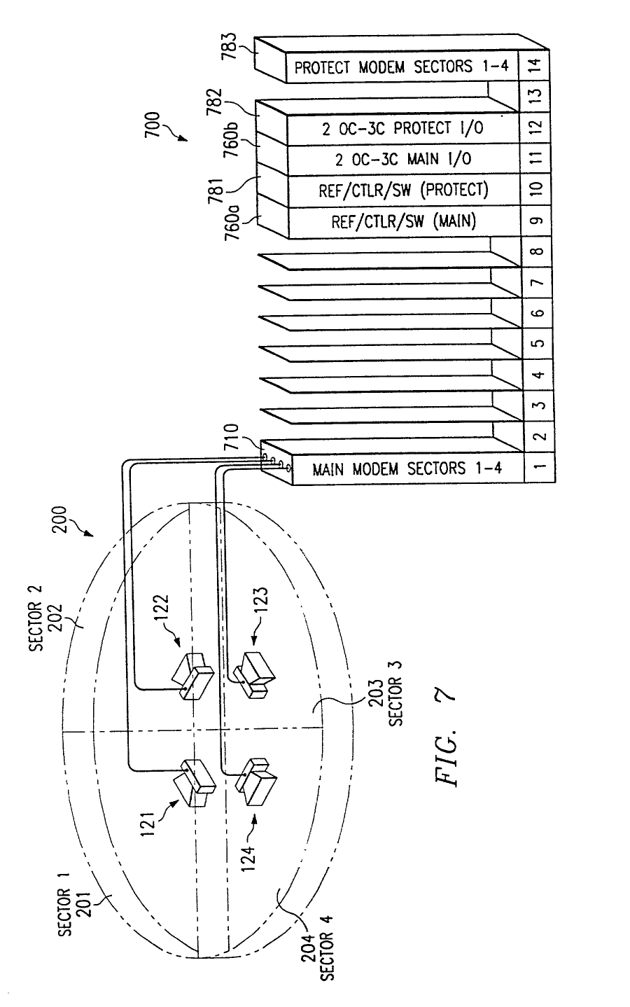

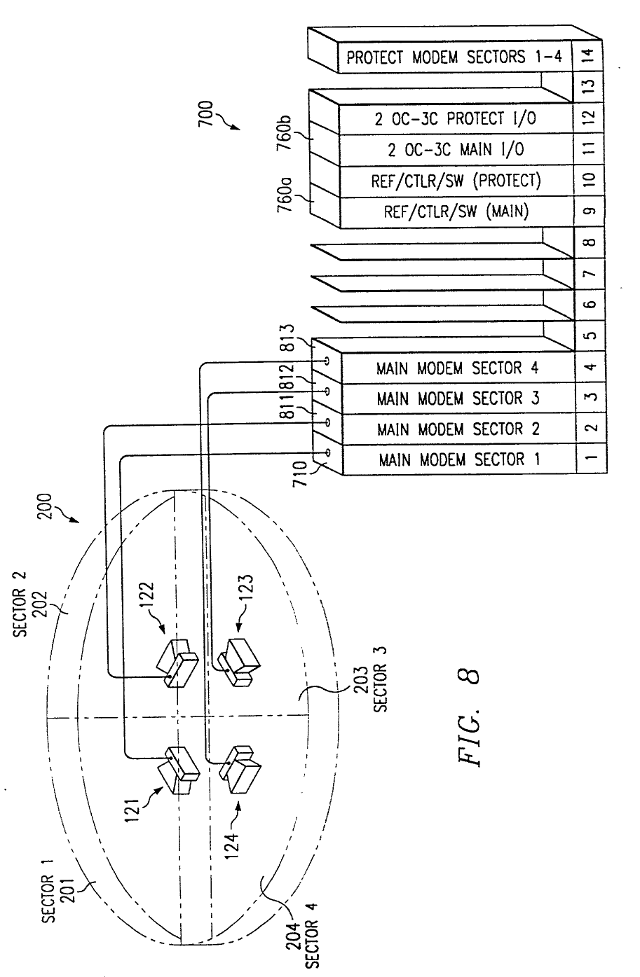

Additionally, a preferred embodiment of the present invention utilizes an expandable communication hub bus assembly such as shown in FIG. 7. The preferred embodiment of FIG. 7 provides expandable bus structure 700 configured substantially as the initial deployment of FIG. IA. Specifically, expandable bus structure 700 has installed therein modem board 710, corresponding to multi-port modem 110, and controller/switch board 760a and I/O board 760b, corresponding to switch 160. Additionally, the preferred embodiment expandable bus structure 700 includes redundancy boards 781-783 which provide communication fault tolerance as shown and described in the above referenced patent application entitled “System and Method for Providing Redundancy in a Sectored Wireless Communication System.” However, the use of redundant components may be omitted, if desired.

It should be appreciated that expandable bus structure 700 includes a plurality of open expansion slots to accept additional boards in providing system configuration alteration according to the present invention. For example, directing attention to FIG. 8, expandable bus structure 700 can be seen having had additional modems installed therein, shown as modems 811, 812, and 813. Accordingly, the configuration shown in FIG. 8 provides increased capacity by coupling each of radio modules 121-124 to a respective modem 710 and 811-813.

It should be appreciated that the expansion bus structure of FIGS. 7 and 8 provide for the expanded capacity of FIG. 8 through installation of modems to expandable bus structure 700 and the decoupling and coupling of radio module links. Accordingly, the expanded capacity is achieved in a centralized location, without requiring the service technician to ascend a mast or other structure associated with radio modules 121-124. Moreover, in the illustrated embodiment, this expanded capacity is achieved without alteration of the controller/switch board 760a and I/O board 760b of FIG. 7.

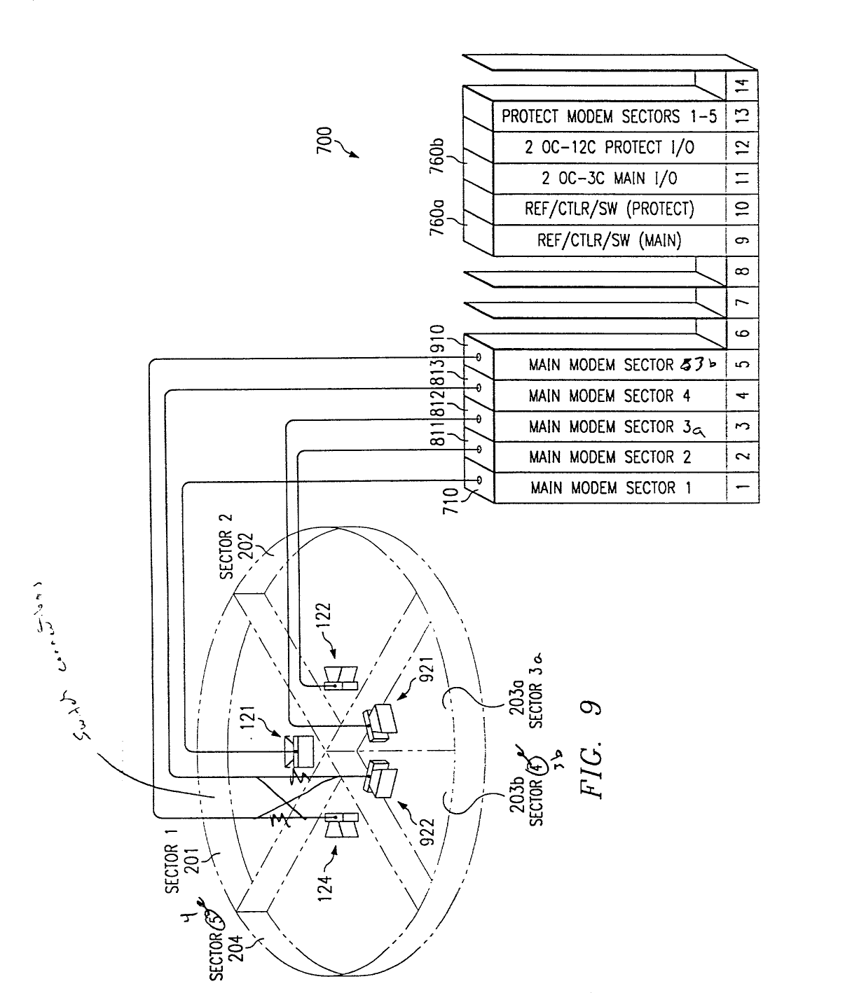

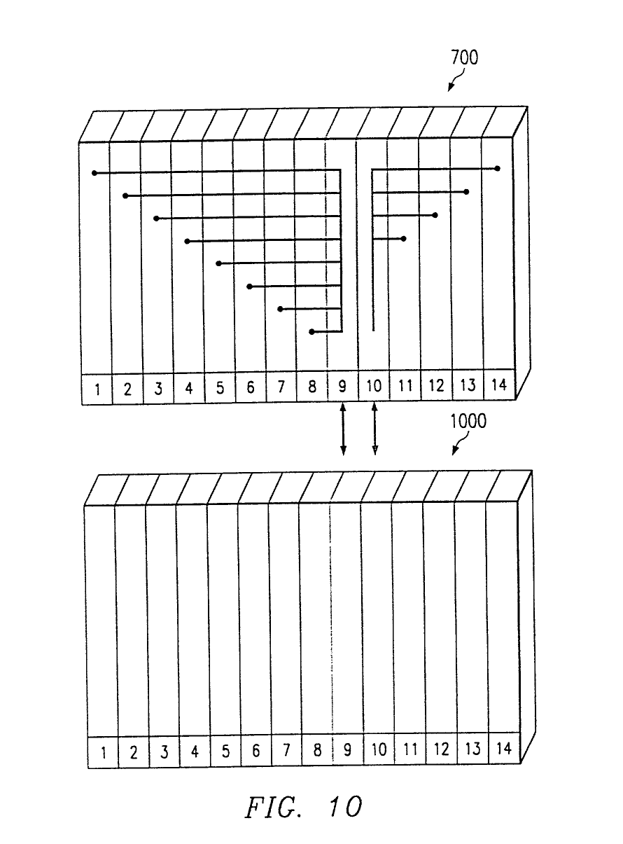

The preferred embodiment bus structure of FIGS. 7 and 8 provide expansion capacity beyond that utilized in the configuration of FIG. 8. Accordingly, not only is subsequent bandwidth demand accommodated through providing each initially deployed sector with its own modem, but such demand may be easily accommodated through further sectorization of the service area. Directing attention to FIG. 9, a configuration wherein bandwidth demand in a particular sector exceeds that serviceable by a single modem and/or radio module is shown. Specifically, bandwidth demand associated with sector 203 has been determined to be sufficient to require capacity in addition to that which is adequately served by modem 812. One embodiment of the present invention may replace modem 812 with a higher capacity modem. However, the use of such a higher capacity modem is expected to require substantial alteration at the remote nodes in communication therewith, such as corresponding modem replacements etc. Accordingly, the preferred embodiment of the present invention divides the sector in to sub-sectors 203a and 203b, using radio modules 921 and 922 having beamwidths associated therewith which are more narrow than that of radio module 123. Correspondingly, another modem, modem 910, is introduced such that modem 812 serves sub-sector 203a and modem 910 serves sub-sector 203b.

It should be appreciated that the modularity of radio modules 210-214 accommodate the further sectorization of service area 200 through a simple interchange of the radio module or modules associated with a region of the service area requiring added capacity. Although it is possible to deploy such alternative radio modules initially, it is expected that the cost of these unused radio modules will outweigh the expense and inconvenience associated with having a service technician ascend the mast for their deployment when required. Accordingly, in the preferred embodiment, this expansion is not accomplished from a single centralized location as that associated with FIG. 8 discussed above.

Although the sub-sector sizes used in providing increased capacity within sector 213 are illustrated in FIG. 9 to be substantially the same, there is no such limitation according to the present invention. For example, it may be desired to provide a large sub-sector and a small sub-sector, such as where a relatively small region includes a large concentration of subscribers. It should be appreciated that this reasoning also holds true for the sectors of service area 200 and, therefore, there is no limitation according to the present invention that any or all the antenna beams be substantially equivalent, whether in width or length. It should also be appreciated that the sectors of the present invention may be partially or completely overlapping, such as to provide the communication capacity of multiple modems within a particular region of service area 200.

According to the preferred embodiment, frequency division channels are utilized between sub-sectors 203a and 203b, thereby introducing an additional channel or channel set with the addition of the radio module or an existing channel set of radio module 213 is divided among radio modules 921 and 922. Accordingly, communications in each of these sub-sectors may be provided substantially simultaneously with and independent of communications associated with the other sub-sector and/or other sectors. However, it should be appreciated that such a frequency division necessitates alteration of communication frequencies at some or all of the remote nodes in sector 203. Accordingly, a preferred embodiment of the present invention utilizes frequency agile remote nodes, such as may be provided by nodes having synthesized radio frequency (RF) front-end modules. Of course, the expansion of capacity through added sub-sectors may be provided by field replacing particular remote nodes to communicate using a new channel or channel set if desired.

Expansion of capacity according to the present invention is not necessarily limited by the number of slots provided in expansion bus structure 700. For example, directing attention to FIG. 10, the present invention may utilize a primary expansion bus structure (700) and a secondary expansion bus structure (1000), such as may be coupled through controller/switch circuitry. Accordingly, a number of expansion components greater than the available slots of a single expansion bus structure may be easily accommodated.

It should be appreciated that the communication bandwidth provided according to the present invention need not be associated with point-to-multipoint communications, i.e., hub to a plurality of remote nodes. For example, a radio module (not shown) having a very narrow, i.e., pencil, beam antenna may be deployed and coupled to a corresponding modem, which may either be coupled to other radio modules as discussed above or dedicated to the very narrow beam radio module. This radio module may be utilized to provide point-to-point communications, such as in order to provide network communication backhaul between communication hubs.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

I claim:

1. A point to multipoint communication system for providing wireless communication between a hub and plural remote nodes, wherein said communication system is adapted to provide plural levels of communication capacity between the hub and the plural remote nodes, said communication system comprising:
said plural nodes, each comprising:
a remote wireless communication link interface for providing wireless communication with said hub; and
an interface operatively connected to one or more remote computer systems;
said hub comprising:
a plurality of wireless communication link interfaces for providing wireless communication with said plural nodes;
a first communication signal processor operatively connected to said plurality of wireless communication link interfaces;
a communication controller operatively connected to an external computer system;
a bus structure operatively connected to said first communication signal processor and to said communication controller, wherein said bus structure is adapted to accept plural communication signal processors and operatively connect said plural communication signal processors to said communication controller to thereby provide plural levels of communication capacity between the hub and the plural nodes.

2. The communication system of claim 1 wherein said plurality of wireless communication link interfaces are adapted to be interchangeably connected to any one of a plurality of communication signal processors.

3. The communication system of claim 2 further comprising a second communication signal processor operatively connected to at least one of the plurality of wireless communication link interfaces and to said bus structure wherein said at least one of the plurality of wireless communication link interfaces is disconnected from said first communication signal processor so as to be connected to said second communication signal processor.

4. The communication system of claim 3 wherein the addition of said second communication signal processor substantially doubles the communication capacity between the hub and the plural nodes.

5. The communication system of claim 3 wherein each of the plurality of wireless communication link interfaces establishes a wireless communication link with at least a one of the plural nodes whereby each one of said wireless communication links is substantially independent of the others of said wireless communication links.

6. The communication system of claim 5 wherein the first and second communication signal processors and each of the plurality of wireless communication link interfaces operate using a common intermediate frequency.

7. The communication system of claim 5 wherein the communication controller is capable of directing information from the external computer system to certain ones of the plural nodes by directing the information to the communication signal processors associated with the wireless communication link between the hub and said certain ones of the plural nodes.

8. The communication system of claim 7 wherein said external computer is selected from the group consisting of: a public switched telephone network, a private network, a private branch exchange, a router, a fiber optic network, and the internet.

9. The communication system of claim 1 wherein said first communication signal processor comprises a modem.

10. The communication system of claim 9 wherein said modem is a multiport modem.

11. The communication system of claim 9 wherein said modem is capable of providing communications at multiple levels of information density.

12. The communication system of claim 11 wherein the communication controller controls the level of information density.

13. The communication system of claim 1 wherein each one of said plurality of wireless communication link interfaces comprises a radio including an antenna with a predetermined beamwidth to provide communications to a predetermined sector.

14. The communication system of claim 13 wherein said radios operate using a common intermediate frequency and ones of said radios operate using a radio frequency that is different than the radio frequency of the others of said radios.

15. The communication system of claim 13 wherein said radios operate in the millimeter frequency range.

16. The communication system of claim 15 wherein ones of said predetermined sectors operate using a communication channel that is different than the communication channels of the others of said predetermined sectors wherein said communication channels comprise a forward portion and a reverse portion.

17. The communication system of claim 16 wherein at least one of the communication channels is a code division multiple access channel.

18. The communication system of claim 16 wherein at least one of the communication channels is a frequency division multiple access channel.

19. The communication system of claim 16 wherein at least one of the communication channels is a time division multiple access channel.

20. The communication system of claim 19 wherein the time division multiple access channel is time division duplexed.

21. The communication system of claim 20 wherein the time division duplexing is asymmetric.

22. The communication system of claim 21 wherein said asymmetry is dynamically adjustable as a function of the ratio of the forward portion and the reverse portion of the communication channel.

23. The communication system of claim 2 further comprising a plurality of communication signal processors whereby each one of the plurality of communication signal processors is operatively connected to:
a separate one of said plurality of wireless communication link interfaces; and
the bus structure.

24. The communication system of claim 23 wherein each of the plurality of wireless communication link interfaces establishes a wireless communication link with at least a one of the plural nodes whereby each one of said wireless communication links is substantially independent of the others of said wireless communication links.

25. The communication system of claim 24 further comprising an additional communication signal processor operatively connected to the bus structure and to a plurality of wireless communication link interfaces to thereby establish a redundant wireless communication link.

26. The communication system of claim 1 further comprising multiple hubs.

27. In a point-to-multipoint adaptive time division duplex system for broadband short distance radio communication in the millimeter frequency range from one computer network to another computer network comprising:
a hub geographically located in a predetermined location and adapted to be operatively connected to a computer network for the communication of bursty data between the computer network and the hub, said hub comprising:
a plurality of wireless communication link interfaces for providing wireless communication with said plural nodes;
a first communication signal processor operatively connected to said plurality of wireless communication link interfaces; and
a communication controller operatively connected to said first communication signal processor and to said computer network; and
a plurality of nodes each geographically spaced from said hub and adapted to be operatively connected to a computer network other than the computer network to which said hub is adapted to be connected for the communication of bursty data between the node and the computer network to which connected, each one of said plurality of nodes comprising:
a remote wireless communication link interface for providing wireless communication with said hub; and
an interface operatively connected to said computer network other than the computer network to which said hub is adapted to be connected;
the improvement comprising a bus structure operatively connected to said first communication signal processor and to said communication controller, wherein said bus structure is adapted to accept plural communication signal processors and operatively connect said plural communication signal processors to said communication controller to thereby provide plural levels of communication capacity between the hub and the plural nodes.

28. A point to multipoint communication system for providing broadband short distance radio communication in the millimeter frequency range between plural remote nodes and a hub including at least one communication signal processor, at least one radio module, and an expandable bus structure for accepting communication signal processors,
wherein said communication system is adapted to provide plural levels of radio communication capacity between the hub and the plural remote nodes by the addition to the hub of equipment selected from the group consisting of:
(a) one or more radio modules;
(b) one or more communication signal processors; and
(c) one or more radio modules and one or more communication signal processors.

29. The communication system of claim 28 wherein the number of radio modules is greater than the number of communication signal processors.

30. The communication system of claim 28 wherein said at least one radio module equals four radio modules.

31. The communication system of claim 30 wherein each of the four radio modules has a 90° azimuthal beamwidth.

32. The communication system of claim 30 wherein the bandwidth of the radios is selected from the group consisting of: 15 °, 30 °, 45°, and 60°.

33. The communication system of claim 28 wherein each of the at least one radio modules operates at the same intermediate frequency.

34. The communication system of claim 33 wherein at least one of the said at least one radio modules operates at a radio frequency different than the radio frequency at which the others of said at least one radio modules operate.

35. The communication system of claim 28 wherein said at least one communication signal processor is a modem.

36. The communication system of claim 35 wherein said modem is a multiport modem.

37. The communication system of claim 28 wherein said communication signal processors are added to the hub via said expandable bus structure.

38. A communication method for providing point to multipoint wireless communication between a hub and plural remote nodes at plural levels of communication capacity, said communication method comprising:
providing said plural nodes, each comprising:
a remote wireless communication link interface for providing wireless communication with said hub; and
an interface operatively connected to one or more remote computer systems;
providing said hub comprising:
a plurality of wireless communication link interfaces for providing wireless communication with said plural nodes;
a first communication signal processor operatively connected to said plurality of wireless communication link interfaces;
a communication controller operatively connected to an external computer system;
a bus structure operatively connected to said first communication signal processor and to said communication controller;
expanding said bus structure to accept plural communication signal processors and operatively connect said plural communication signal processors to said communication controller to thereby provide plural levels of communication capacity between the hub and the plural nodes.

39. The communication method of claim 38 further comprising the step of adapting said plurality of wireless communication link interfaces to be interchangeably connected to any one of a plurality of communication signal processors.

40. The communication method of claim 39 further comprising the step of operatively connecting a second communication signal processor to at least one of the plurality of wireless communication link interfaces and to said bus structure wherein said at least one of the plurality of wireless communication link interfaces is disconnected from said first communication signal processor so as to be connected to said second communication signal processor.

41. The communication method of claim 40 wherein the addition of said second communication signal processor substantially doubles the communication capacity between the hub and the plural nodes.

42. The communication method of claim 40 wherein each of the plurality of wireless communication link interfaces establishes a wireless communication link with at least a one of the plural nodes whereby each one of said wireless communication links is substantially independent of the others of said wireless communication links.

43. The communication method of claim 42 further comprising the step of operating the first and second communication signal processors and each of the plurality of wireless communication link interfaces using a common intermediate frequency.

44. The communication method of claim 42 further comprising the step of directing the flow of information from the external computer system to certain ones of the plural nodes by selectively controlling the communication controller so as to direct the flow of information to the communication signal processors associated with the wireless communication link between the hub and said certain ones of the plural nodes.

45. The communication method of claim 44 wherein said external computer is selected from the group consisting of: a public switched telephone network, a private network, a private branch exchange, a router, a fiber optic network, and the internet.

46. The communication method of claim 38 wherein said first communication signal processor comprises a modem.

47. The communication method of claim 46 wherein said modem is a multiport modem.

48. The communication method of claim 46 wherein said modem is capable of providing communications at multiple levels of information density.

49. The communication method of claim 48 further comprising the step of controlling the level of information density by selectively controlling the communication controller.

50. The communication method of claim 38 wherein each one of said plurality of wireless communication link interfaces comprises a radio including an antenna with a predetermined beamwidth to provide communications to a predetermined sector.

51. The communication method of claim 50 further comprising the step of operating said radios using a common intermediate frequency and operating ones of said radios using a radio frequency that is different than the radio frequency of the others of said radios.

52. The communication method of claim 50 wherein said radios operate in the millimeter frequency range.

53. The communication method of claim 52 further comprising the step of operating ones of said predetermined sectors using a communication channel that is different than the communication channels of the others of said predetermined sectors wherein said communication channels comprise a forward portion and a reverse portion.

54. The communication method of claim 53 wherein at least one of the communication channels is a code division multiple access channel.

55. The communication method of claim 53 wherein at least one of the communication channels is a frequency division multiple access channel.

56. The communication method of claim 53 wherein at least one of the communication channels is a time division multiple access channel.

57. The communication method of claim 56 wherein the time division multiple access channel is time division duplexed.

58. The communication method of claim 57 wherein the time division duplexing is asymmetric.

59. The communication method of claim 58 further comprising the step of dynamically adjusting said asymmetry as a function of the ratio of the forward portion and the reverse portion of the communication channel.

60. The communication method of claim 39 further comprising the step of providing a plurality of communication signal processors whereby each one of the plurality of communication signal processors is operatively connected to:
a separate one of said plurality of wireless communication link interfaces; and
the bus structure.

61. The communication method of claim 60 wherein each of the plurality of wireless communication link interfaces establishes a wireless communication link with at least a one of the plural nodes whereby each one of said wireless communication links is substantially independent of the others of said wireless communication links.

62. The communication method of claim 61 further comprising the step of providing an additional communication signal processor operatively connected to the bus structure and to a plurality of wireless communication link interfaces to thereby establish a redundant wireless communication link.

63. The communication method of claim 38 further comprising the step of providing multiple hubs.

64. A method for providing point to multipoint adaptive time division duplex broadband short distance radio communication in the millimeter frequency range between plural remote nodes and a hub, said method comprising the steps of:
providing at least one communication signal processor at the hub;
providing at least one radio module at the hub;
providing an expandable bus structure for accepting communication signal processors at the hub;
adapting said communication system to provide plural levels of radio communication capacity between the hub and the plural remote nodes by the addition to the hub of equipment selected from the group consisting of:
(a) one or more radio modules;
(b) one or more communication signal processors; and
(c) one or more radio modules and one or more communication signal processors.

65. The communication method of claim 64 wherein the number of radio modules is greater than the number of communication signal processors.

66. The communication method of claim 64 wherein said at least one radio module equals four radio modules.

67. The communication method of claim 66 wherein each of the four radio modules has a 90° azimuthal beamwidth.

68. The communication system of claim 64 wherein the bandwidth of the radios is selected from the group consisting of: 15°, 30°, 45°, and 60°.

69. The communication method of claim 64 wherein each of the at least one radio modules operates at the same intermediate frequency.

70. The communication method of claim 69 wherein at least one of the said at least one radio modules operates at a radio frequency different than the radio frequency at which the others of said at least one radio modules operate.

71. The communication method of claim 64 wherein said at least one communication signal processor is a modem.

72. The communication method of claim 71 wherein said modem is a multiport modem.

73. The communication method of claim 64 comprising the additional step of adding said communication signal processors to the hub via said expandable bus structure.
